(19) United States
(12) Patent Application Publication
(10) Pub. No.: US 2018/0247027 A1
(43) Pub. Date: Aug. 30, 2018

(54) PATIENT EDUCATION AND MONITORING

(71) Applicant: Eric Rivedal, Denver, CO (US)

(72) Inventor: Eric Rivedal, Denver, CO (US)

(73) Assignee: Ricoh Company, Ltd., Tokyo (JP)

(21) Appl. No.: 15/443,814

(22) Filed: Feb. 27, 2017

(51) Int. Cl. G06F 19/00; G09B 19/00; G09B 5/06

(52) U.S. Cl. CPC G06F 19/3406; G06F 19/3456; G06F 19/328; G09B 5/065; G09B 19/00

(57) ABSTRACT

A patient interface to a patient engagement and education system is disclosed for receiving education assets assigned to a patient, and monitoring whether the patient has viewed the education assets. The patient interface queries a server for an education asset assigned to the patient, and receives the education asset from the server. The patient interface displays the education asset to the patient at a Graphical User Interface (GUI), and determines that the patient has viewed the education asset. The patient interface provides a message to the server in response to the determination to allow the server to compile compliance information indicating that the education asset has been viewed by the patient.

### RELATED APPLICATIONS

This document is related to co-pending U.S. patent application Ser. No. 15/443,557 (client docket No. 1-921_FN201609430, filed on Feb. 27, 2017 and identically titled), co-pending U.S. patent application Ser. No. 15/443,720 (client docket No. 1-922_FN201609431, filed on Feb. 27, 2017 and identically titled), and co-pending U.S. patent application Ser. No. ______ ((client docket No. 1-936_FN201609433, filed on Feb. 27, 2017 and identically titled), each of which is incorporated herein by reference.

### FIELD OF THE INVENTION

The invention relates to the field of patient care, and in particular, to patient education and follow-up after discharge.

### BACKGROUND

Hospitals are experiencing expensive readmissions of patients, often because the patients do not understand their discharge instructions or follow up care requirements. Health care providers are required to assure that the condition of the patients improve, but they do not have control over the behavior of the patients after they leave the hospital or clinic.

The U.S. Affordable Care Act (ACA) introduced a Hospital Readmissions Reduction Program (HRRP), which requires that the Centers for Medicare and Medicaid Services (CMS) reduce payments to hospitals that have excess readmissions. Therefore, hospitals have a financial motivation to reduce the potential for patient readmission.

For patients who are discharged to a home environment, the hospitals have a goal to keep the patient healthy and at home as long as possible, preventing a costly readmission of the patient to the hospital. Follow up is critical when patients are not engaged with their care and aware of the steps they need to take to stay healthy at home. Follow up usually takes place in the form of a personal phone call from the hospital staff. A simple phone call can answer questions and clarify treatments that may not have been fully understood or complied with, preventing readmission. However, these calls are resource intensive and can incur a cost to the hospital if they are not directed to those patients who need the most follow up care. Finding those at-risk patients is a challenge.

Medicare and most insurance providers will deny payment for hospitalization of patients that are admitted within one month of their previous discharge for the same condition. There are a number of reasons why a patient may be readmitted for the same condition. One reason is that the patient may not understand the instructions for home care given at discharge from the hospital. Some patients may not speak English, or may have a limited understanding of English. This may be a problem if the educational materials that the patient is given are only provided in English. Another reason may be that the patient may not understand the instructions given to them, or they may forget to take their medication. Therefore, there is a need to prevent patient readmission, which can occur for a number of factors.

### SUMMARY

A patient interface to a patient engagement and education system is disclosed for receiving education assets assigned to a patient, and monitoring whether the patient has viewed the education assets. The patient interface queries a server for an education asset assigned to the patient, and receives the education asset from the server. The patient interface displays the education asset to the patient at a Graphical User Interface (GUI), and determines that the patient has viewed the education asset. The patient interface provides a message to the server in response to the determination to allow the server to compile compliance information indicating that the education asset has been viewed by the patient.

One embodiment comprises a patient engagement and education system that includes a user interface and a control system. The user interface displays a Graphical User Interface (GUI) to a patient. The control system is communicatively coupled to the user interface and to a server. The control system queries the server for an education asset assigned to the patient, receives the education asset from the server, and displays the education asset to the patient at the GUI. The control system makes a determination that the patient has viewed the education asset, and provides a message to the server in response to the determination to allow the server to compile compliance information indicating that the education asset has been viewed.

Another embodiment comprises a method of receiving education assets and monitoring compliance with viewing the education assets by a patient. The method comprises querying a server for an education asset assigned to a patient, receiving the education asset from the server, and displaying the education asset to the patient at a Graphical User Interface (GUI). The method further comprises making a determination that the patient has viewed the education asset, and providing a message to the server in response to the determination to allow the server to compile compliance information indicating that the education asset has been viewed.

Another embodiment comprises a non-transitory computer-readable medium having programmed instructions which, when executed by a processor, direct the processor to query a server for an education asset assigned to a patient, receive the education asset from the server, and display the education asset to the patient at a Graphical User Interface (GUI). The instructions further direct the processor to make a determination that the patient has viewed the education asset, and to provide a message to the server in response to the determination to allow the server to compile compliance information indicating that the education asset has been viewed.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a patient education and engagement system in an exemplary embodiment.

FIG. 2 is a flow chart of a method of assigning education assets to a patient in an exemplary embodiment.

FIG. 3 is a flow chart of a method of assigning variable data to education assets for a patient in an exemplary embodiment.

FIG. 4 is a flow chart of a method of assigning reminders to a patient in an exemplary embodiment.

FIG. 5 is a flow chart illustrating additional details of the method of FIG. 4 in an exemplary embodiment.

FIG. 6 is a flow chart of a method of providing an electronic delivery of education assets to a patient in an exemplary embodiment.

FIG. 7 is a flow chart of a method analyzing compliance for education assets assigned to a patient in an exemplary embodiment.

FIG. 8 is a flow chart of a method of providing an electronic delivery of reminders to a patient in an exemplary embodiment.

FIG. 9 is a flow chart of a method of analyzing compliance for reminders assigned to a patient in an exemplary embodiment.

FIG. 10 is a flow chart of a method of providing an electronic receipt of education assets assigned to a patient in an exemplary embodiment.

FIG. 11 is a flow chart of a method of generating compliance information for education assets assigned to a patient in an exemplary embodiment.

FIG. 12 is a flow chart of a method of providing an electronic receipt of reminders assigned to a patient in an exemplary embodiment.

FIG. 13 is a flow chart of a method of determining compliance for education assets assigned to a patient in an exemplary embodiment.

FIG. 14 is a flow chart of a method of determining a re-admittance risk for patients based on education asset compliance in an exemplary embodiment.

FIG. 15 is a flow chart of a method of determining compliance for reminders assigned to patients in an exemplary embodiment.

FIG. 16 is a flow chart of a method of determining a re-admittance risk for patients based on reminder compliance in another exemplary embodiment.

FIG. 17 is a block diagram of a computer system for implementing the functionality described herein in an exemplary embodiment.

FIGS. 18-21 illustrate various user interfaces that may be presented by the system of FIG. 1 in exemplary embodiments.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

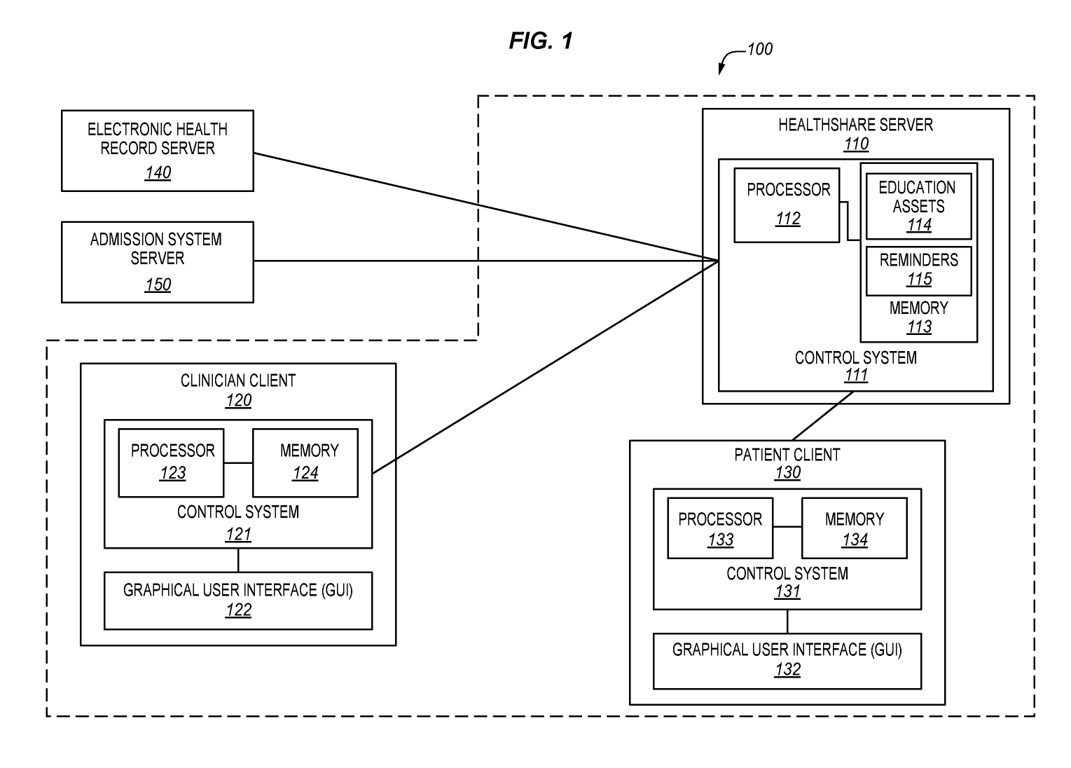

FIG. 1 is a block diagram of a patient engagement and education system 100 in an exemplary embodiment. System 100 is able to perform various functions regarding the goal of providing a patient with the post-discharge tools they may need to ensure that the patient is able to avoid a possible readmission into a hospital or clinic. In general, system 100 is capable of assigning various education assets (e.g., education videos, education documents, etc.), post-discharge instructions (e.g., exercises, wound care, etc.), and reminders (e.g., medication reminders, follow-up appointment reminders, etc.) to a patient. System 100 is also able to automate the electronic delivery of education assets, post-discharge instructions, and reminders to a patient, and to monitor the compliance of the patient in reviewing the education assets, reviewing and performing the post-discharge instructions, and complying with the reminders. System 100 is further capable of identifying patients that are at-risk for readmission based on a number of metrics, including the compliance data compiled for the patient, variations in compliance over time by the patient, patient demographics, education, primary language, etc. System 100 also includes the ability to modify the patient education plan (e.g., education assets and/or reminders) as needed.

Patient privacy and security are required by the Health Insurance Portability & Accountability Act (HIPAA), initially enacted in 1999. Hospitals are required to assure that patients' Personal Health Information (PHI) is protected from view by any party not approved by the patient. The general interpretation of this rule is that PHI data must be encrypted both at rest and in transit, and that patients must have a way to approve who is allowed to see that information. System 100 utilizes encryption, and accessing system 100 may require ID's and Passwords to access information. The messages passed between the various elements of system 100 may be encrypted, and patients may be required to approve a caregivers' access to their PHI data.

In this embodiment, system 100 includes a healthshare server 110, which operates as the central asset distribution element and compliance monitoring element of system 100. Healthshare server 110 stores education assets 114, which may comprise educational videos, educational documents, etc., for a patient. For example, healthshare server 110 may store educational videos and/or educational documents regarding various medical conditions (e.g., high blood pressure, diabetes, blood clots, heart attack, cancer, medication schedules, etc.) which may be assigned to a patient. Healthshare server 110 also stores reminders 115, which are assigned to a patient. Reminders 115 may include medication dosing reminders, follow-up appointment reminders, exercise reminders, wound care reminders, etc.

In this embodiment, healthshare server 110 includes a control system 111, which implements the functionality described herein for healthshare server 110. While the specific hardware implementation of control system 111 is subject to design choices, one particular embodiment may include one or more processors 112 communicatively coupled with memory 113. Processor 112, and any subsequent processor element described herein, includes any electronic circuits and/or optical circuits that are able to perform functions. For example, processor 112 may perform any functionality described herein for control system 111 and/or healthshare server 110. Processor 112, and any subsequent processor element described herein, may include one or more Central Processing Units (CPU), microprocessors, Digital Signal Processors (DSPs), Application-specific Integrated Circuits (ASICs), Programmable Logic Devices (PLDs), control circuitry, etc. Some examples of processors include INTEL® CORE™ processors, Advanced Reduced Instruction Set Computing (RISC) Machines (ARM®) processors, etc.

Memory 113, and any subsequent memory element described herein, includes any electronic circuits, and/or optical circuits, and/or magnetic circuits that are able to store data. For instance, memory 113 may store education assets 114, may store reminders 115, may store programmed instructions for processor 112 to implement the functionality described herein for control system 111, etc. Memory 113, and any subsequent memory element described herein, may include one or more volatile or non-volatile Dynamic Random Access Memory (DRAM) devices, FLASH devices, volatile or non-volatile Static RAM devices, magnetic disk drives, Solid State Disks (SSDs), etc. Some examples of non-volatile DRAM and SRAM include battery-backed DRAM and battery-backed SRAM.

In this embodiment, system 100 further includes a clinician client 120, which allows a clinician to assign education assets 114 to a patient, assign reminders 115 to a patient, enter charting information for a patient, and to display compliance information for a patient. Clinician client 120 includes a control system 121, which implements the functionality described herein for clinician client 120. While the specific hardware implementation of control system 121 is subject to design choices, one particular embodiment may include one or more processors 123 communicatively coupled with a memory 124. Memory 124 may store programmed instructions for processor 123 to implement the functionality described herein for control system 121 and/or clinician client 120.

Control system 121 of clinician client 120 is communicatively coupled to a Graphical User Interface (GUI) 122, which allows a user to interact with clinician client 120. Some examples of GUI 122 include display devices, touch screens, keyboards, etc. Clinician client 120 may comprise a personal computer, a mobile device (a tablet computer, a mobile phone), etc.

System 100 in this embodiment further includes a patient client 130, which allows a patient to download and view education assets 114, receive reminders 115, enter compliance information, etc. Patient client 130 includes a control system 131, which implements the functionality described herein for patient client 130. While the specific hardware implementation of control system 131 is subject to design choices, one particular embodiment may include one or more processors 133 communicatively coupled with a memory 134. Memory 134 may store programmed instructions for processor 133 to implement the functionality described herein for control system 131 and/or patient client 130. Control system 131 of patient client 130 is communicatively coupled to a Graphical User Interface (GUI) 132, which allows a patient to interact with patient client 130. Some examples of GUI 132 include display devices, touch screens, keyboards, etc. Patient client 130 may comprises a personal computer, a mobile device (e.g., a tablet computer, a mobile phone), etc. Patient client 130 may be sent home with the patient by the hospital, for use during a post-discharge period. While patient client 130 may include PHI, loss of patient client 130 may be mitigated by a remote wipe of patient client 130 by healthshare server 110.

In this embodiment, control system 111 of healthshare server 110 may communicate with an electronic health record server 140, which provides electronic medical records for patients to system 100. System 100 may utilize the electronic medical record for a patient to automatically assign education assets 114 to the patient and/or automatically pre-select education assets 114 displayed to a clinician using clinician client 120. System 100 may also utilize the electronic medical record for the patient to automatically generate reminders 115 for the patient and/or automatically display reminders 115 to a clinician using clinician client 120 based on the medical conditions for the patient that are described in the electronic health record. For example, system 100 automatically assigns and/or automatically pre-selects education assets 114 for a patient related to high blood pressure when the electronic medical record indicates medical test data for high blood pressure, and/or system 100 automatically generates and/or displays reminders 115 to a patient for taking blood pressure medication when the electronic medical record indicates a prescription for high blood pressure medication.

In this embodiment, control system 111 of healthshare server 110 may communicate with an admission system server 150, which provides demographics and dietary information of the patients to system 100. System 100 may utilize the demographic information and dietary information for the patient to automatically assign and/or pre-select education assets 114 for the patient, to automatically generate and/or display reminders for the patient to the clinician using clinician client 120, etc. For instance, the dietary restrictions for a patient may be used to automatically assign and/or pre-select education assets 114 and/or automatically generate and/or display reminders 115 for the patient to the clinician using clinician client 120, while any language limitations the patient may have (e.g., the patient only speaks Spanish) would be used by system 100 to assign a language-appropriate education asset 114 and/or reminders 115 for the patient.

In some embodiments, admission system server 150 and/or electronic health record server 140 may communicate with healthshare server 110 utilizing Health Level Seven (HL7) messages, which consist of groups of segments in a defined sequence. The segments in an HL7 message may be optional, required, and/or repeatable. The HL7 message type defines the purpose for the message being sent and is present in every HL7 message. Message types are identified by a three-character code, and are used in conjunction with a trigger event. An HL7 trigger event is a real-world event that initiates communication and the sending of a message, and is shown as part of the message type. Both the message type and trigger event are found in the MSH-9 field of the message. For example, the MSH-9 field might contain the value ADT-A01. This means that ADT is the HL7 message type, and A01 is the trigger event. In the HL7 Standard, an ADT-A01 message is known as a “patient admit” message. Each message type and trigger event within a specific HL7 version has a defined format. There are some message types and triggers that have the exact same format, such as ADT-A01, ADT-A04, ADT-A05 and ADT-A08. But in many cases, the formats vary widely. Some examples of HL7 message types includes Demographics (ADT), Orders (ORM), Results (ORU), and Charges (DFT). Some examples of HL7 trigger events for Demographics includes admit a patient (A01), transfer (A02), discharge (A03), and register (A04). One example of an HL7 trigger event for Orders includes send and order (O01), while another example of an HL7 trigger event for Results is send order results (R01).

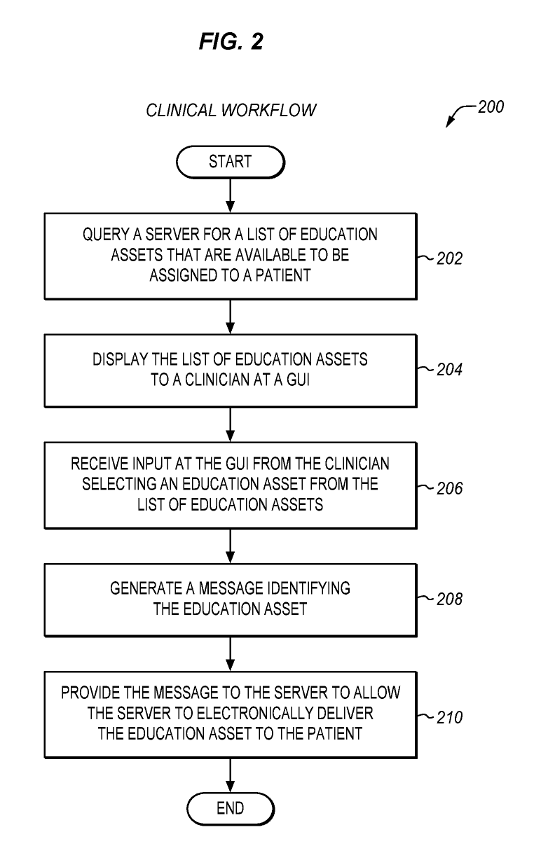

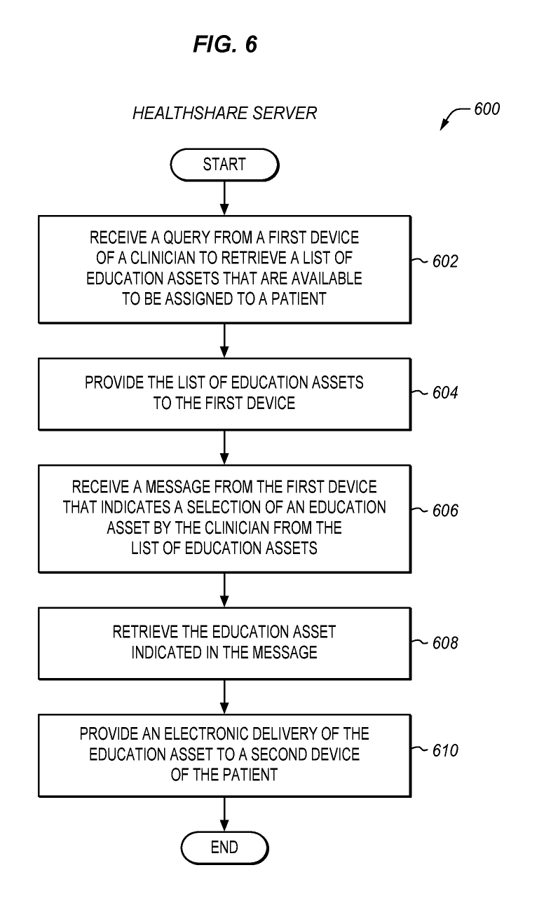

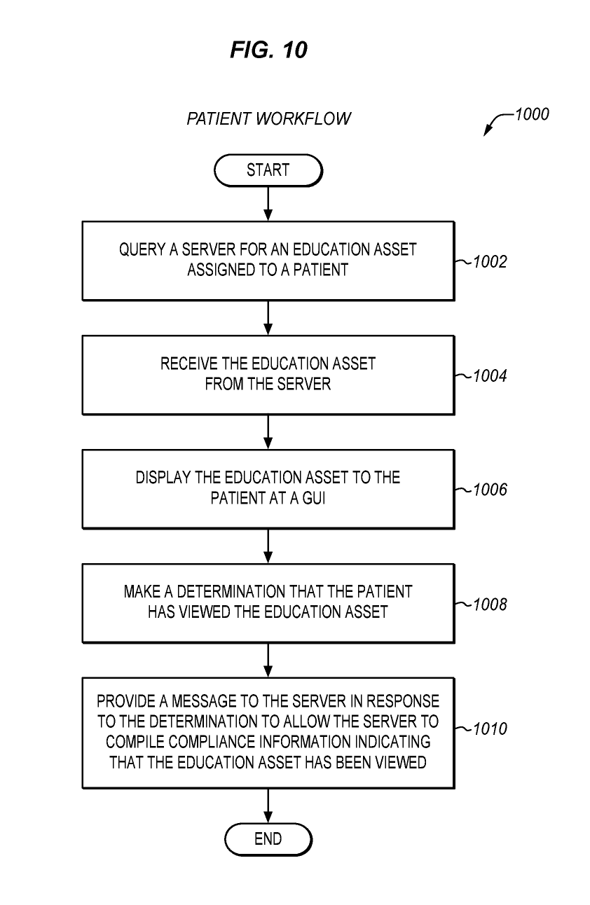

Consider that system 100 is in operation, and a clinician wishes to utilize system 100 to assign one or more education assets 114 to a patient. The functionality of system 100 will be described with respect to various workflows that will detail how different elements of system 100 interact. One workflow is a clinical workflow, which relates to how a clinician would interact with system 100 utilizing clinician client 120 to build an education plan for a patient. FIGS. 2-5 are related to the clinical workflow. Another workflow is performed by healthshare server 110, which coordinates the activities for the various elements in FIG. 1, and is described in FIGS. 6-9. Another workflow is a patient workflow, which relates to how a patient would interact with system 100 utilizing patient client 130 to interact with the education plan. FIGS. 10-12 are related to the patient workflow. Another workflow is a clinician follow-up workflow, which relates to how a clinician would interact with system 100 utilizing clinician client 120 to monitor the compliance of the patient with the education plan.

FIG. 2 is a flow chart of a method 200 of assigning education assets to a patient in an exemplary embodiment. The methods herein will be described with respect to system 100 of FIG. 1, although methods may be implemented by other systems, not shown. The steps of the flow charts described herein may include other steps, not shown. Also, the steps of the flow charts described herein may be performed in an alternate order.

One aspect of patient engagement and an education is the use of education assets 114 to provide information to enable the patient to better care for themselves and thus, reduce the possibility of a re-admittance of the patient to a medical facility after discharge. A clinician is able to utilize system 100 to assign various education assets 114 to a patient for electronic delivery to patient client 130.

To do so, a clinician operates clinician client 120, and logs in to system 100 using GUI 122. For example, clinician client 120 may utilize GUI 122 to display a web browser, which the clinician uses to log into healthshare server 110. The clinician begins to build an education plan for the patient using clinician client 120. The education plan is tailored to the patient based on their medical needs and the follow up care that may be scheduled for the patient.

The clinician uses clinician client 120 to query healthshare server 110 for a list of education assets 114 that are available to be assigned to a patient (see step 202). For example, the clinician may utilize GUI 122 of clinician client 120 to display a web screen generated by healthshare server 110, which allows control system 121 of clinician client 120 to generate a request for healthshare server 110. Healthshare server 110 receives the query from control system 121, and generates information regarding education assets 114 that are available. Healthshare server 110 may query electronic health record server 140 for the electronic medical records for the patient, which may be used to determine which of education assets 114 may be relevant to the patient. Healthshare server 110 may also query admission system server 150 for language information, and/or dietary information, and/or prescription information for the patient, which may be used to determine which of education assets 114 may be relevant to the patient.

Healthshare server 110 provides the information back to control system 121, which is displayed on GUI 122 (see step 204). Using GUI 122, the clinician reviews education assets 114 that are available to be assigned to the patient, and provides input at GUI 122 selecting which of education assets 114 will be assigned to the patient (see step 206).

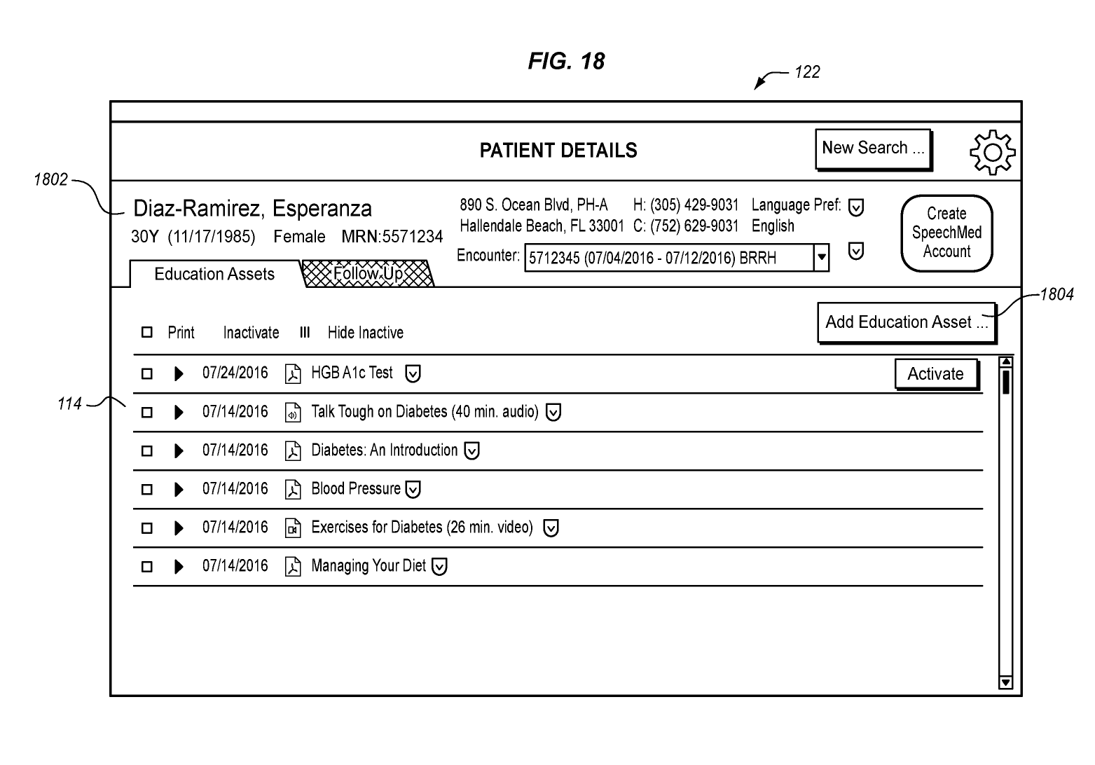

FIG. 18 illustrates a UI screen that may be presented to the clinician at GUI 122 for reviewing and assigning education assets 114 to a patient in an exemplary embodiment. In FIG. 18, a patient 1802 “Diaz-Ramirez, Esperanza” is illustrated as having a number of education assets 114 already assigned. For instance, “Talk Tough on Diabetes”, “Managing Your Diet”, etc. An “Add Education Asset” button 1804 may be used by the clinician to display a list of education assets 114 that may be assigned to a patient 1802.

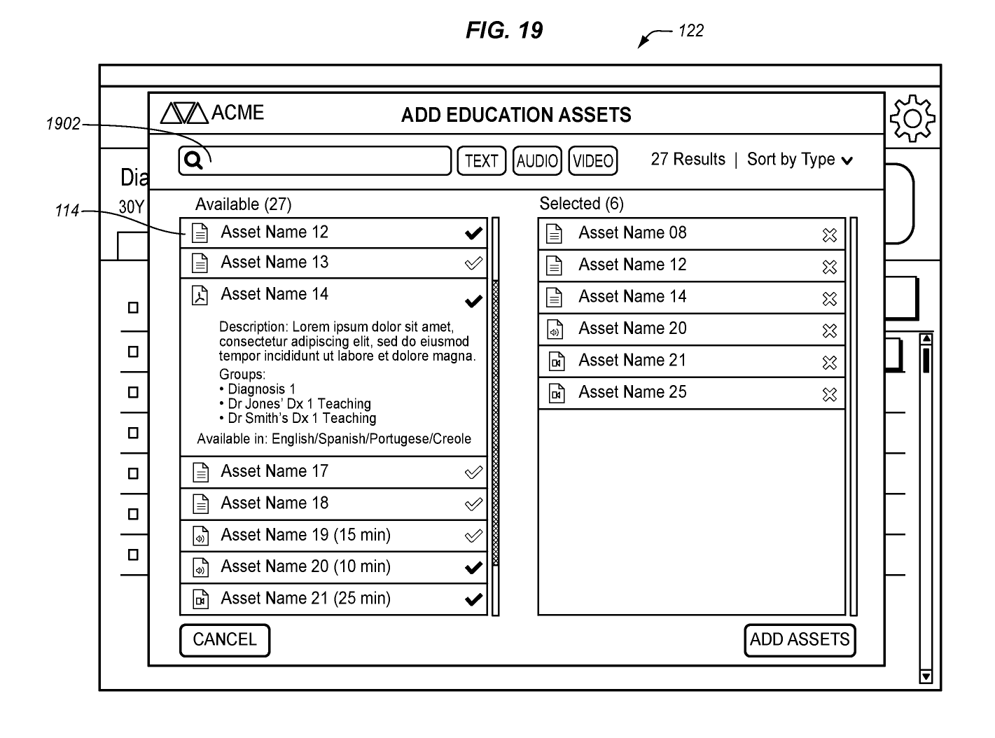

FIG. 19 illustrates a UI screen that may be presented to the clinician at GUI for assigning education assets 114 to patient 1802 in an exemplary embodiment. FIG. 19 illustrates a number of education assets 114 that are “Available” for assignment to patient 1802 and “Selected” for assignment to patient 1802. The clinician may also search through education assets 114 that are available for assignment using the search field 1902.

Using the information provided by the clinician regarding the selected or assigned education assets 114, control system 121 generates a message that identifies education assets 114 that have been selected by the clinician for the patient (see step 208). Control system 121 provides the message to healthshare server 110 to allow healthshare server 110 to electronically deliver the selected education assets 114 to the patient via patient client 130 (see step 210). In some embodiments, healthshare server 110 forwards the message in HL7 format to electronic health record server 140 for storage in the permanent record of the patient. The specific details of how a patient may interact with patient client 130 to view education assets 114 assigned to them will be discussed later.

In some embodiments, the clinician and/or healthshare server 110 may assign variable data to education assets 114 for the patient. For example, the variable data may comprise instructions to the patient regarding the scheduling of future medical care, which is embedded into education assets 114 that are assigned to the patients (e.g., “Please make a follow up appointment with your primary care physician in one month”). The variable data may comprise medication dosages and schedules, which is embedded into education assets 114 that are assigned to the patient (e.g., “Take one 2 mg Coumadin tablet 2× per day with food”). The variable data may comprise instructions to the patient regarding the frequency and/or the type of physical therapy exercises to perform (e.g., “Perform all exercises assigned on the physical therapy sheet 3× per day”).

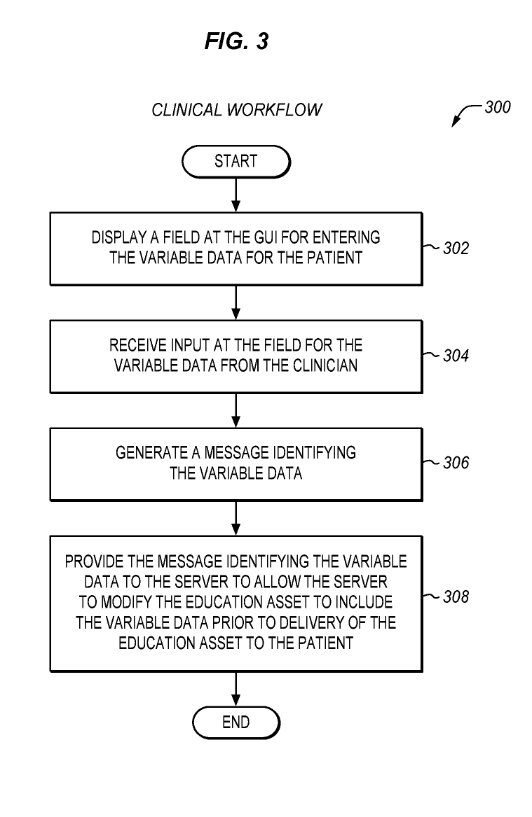

FIG. 3 is a flow chart of a method 300 of assigning variable data to education assets 114 for a patient in an exemplary embodiment. As discussed previously, education assets 114 that are assigned to a patient may be modified to include variable data. The variable data is assigned by the clinician utilizing clinician client 120, and/or automatically assigned by healthshare server 110. For example, when the clinician is assigning education assets 114 to the patient using GUI 122, control system 121 may display a data entry field using GUI 122 (see step 302). The clinician is then able to enter the variable data at GUI 122 into the field (see step 304). Using the information provided by the clinician regarding the variable data, control system 121 generates a message that identifies the variable data that has been entered by the clinician (see step 306). Control system 121 provides the message indicating the variable data to healthshare server 110 to allow healthshare server 110 to modify education assets 114 assigned to the patient prior to delivering education assets 114 to the patient via patient client 130 (see step 308). In some embodiments, healthshare server 110 forwards the message in HL7 format to electronic health record server 140 for storage in the permanent record of the patient.

In some embodiments, the variable data may comprise medical test data for the patient. For example, the clinician may enter in blood pressure information as the variable data, which allows healthshare server 110 to modify education assets 114 assigned to the patient based on the blood pressure information. Healthshare server 110 may, for instance, include the blood pressure information as text data into a video clip that discusses medical conditions related to high or low blood pressure. This allows the patient to relate the information in the video to their specific medical test data.

In some embodiments, control system 121 of clinician client 120 may query healthshare server 110 for an electronic heath record of the patient, which is returned to control system 121 of clinician client 120 by healthshare server 110. Control system 121 of clinician client 120 may the extract the medical test data from the electronic health record. Healthshare server 110, responsive to the request, may generate a request for the patients' electronic heath record (e.g., in HL7 format) and transmit the request to electronic health record server 140, which responds to the request from healthshare server 110 with the requested information.

Another aspect of patient engagement and an education is the use of reminders 115 to assign tasks to a patient, and to remind the patient to perform such tasks. Reminders reduce the possibility of a re-admittance of the patient to a medical facility after discharge. A clinician is able to utilize system 100 to create and assign reminders 115 to a patient for electronic delivery to patient client 130.

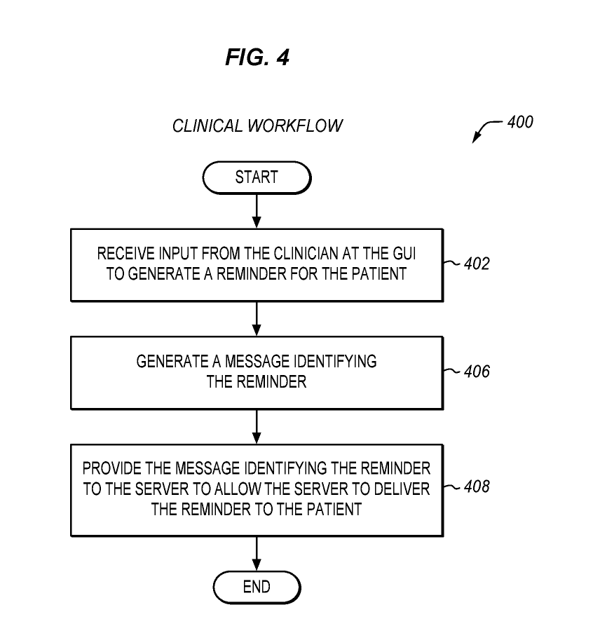

FIG. 4 is a flow chart of a method 400 of assigning reminders to a patient in an exemplary embodiment. As discussed previously, reminders 115 may be provided to the patient to ensure that the patient attends follow up appointments, takes their medication on time and with the correct dose, performs their assigned exercises, etc. These reminders are created/assigned by the clinician utilizing clinician client 120.

The clinician uses clinician client 120 to enter input at GUI 122 to generate a reminder for a patient (see step 402). GUI 122 may display a web screen generated by healthshare server 110, which allows control system 121 to generate a reminder. Control system 121 generates a message that identifies the reminder for the patient (see step 406). Control system 121 provides the message to healthshare server 110 to allow healthshare server 110 to electronically deliver reminders 115 to the patient via patient client 130 (see step 408). In some embodiments, healthshare server 110 forwards the message in HL7 format to electronic health record server 140 for storage in the permanent record of the patient. The specific details of how a patient may interact with patient client 130 to receive and/or interact with reminders 115 assigned to them will be discussed later.

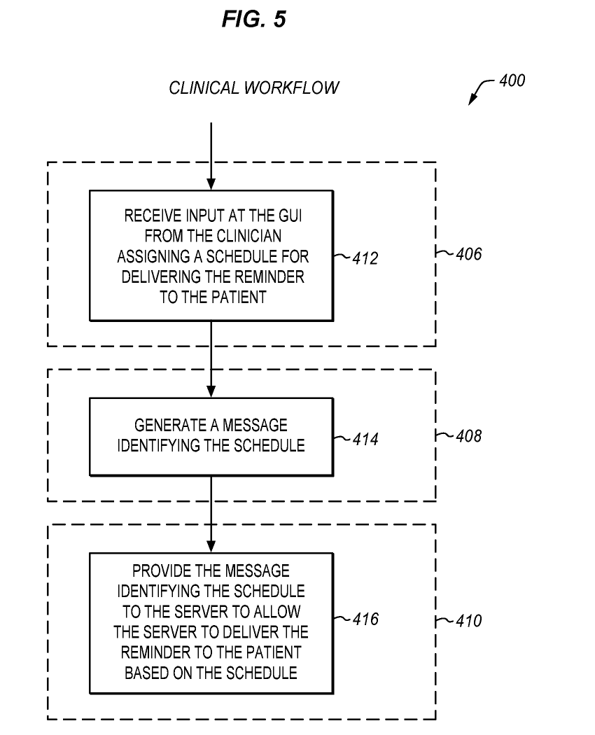

FIG. 5 is a flow chart illustrating additional details of method 400 in an exemplary embodiment. As discussed previously, reminders 115 may be provided to the patient to ensure that the patient attends follow up appointments, takes their medication on time and with the correct dose, performs their assigned exercises, etc. These reminders are created and/or assigned by the clinician utilizing clinician client 120 (or by healthshare server 110). The clinician and/or healthshare server 110 may also assign a schedule for delivering the reminders. For example, the clinician and/or healthshare server 110 may assign a schedule based on how often the patient takes their medication during the day, how often the patient is supposed to perform their assigned exercises, what day and time any follow up appointments have been schedule for the patient, etc. For example, GUI 122 may display a data entry screen with data entry points for a title, a start date, an end data, the days of the week, and times of day for the reminder. Additional user interface elements may allow the clinician to attach or link a photograph to the reminder, to attach or link education assets 114 to the reminder, etc.

The clinician uses clinician client 120 to assign a schedule for the reminders assigned to the patient. Using GUI 122, the clinician enters a schedule for reminders 115 (see step 412). Using the information provided by the clinician regarding the schedule for reminders 115, control system 121 generates a message that identifies the schedule (see step 414). Control system 121 provides the message identifying the schedule to healthshare server 110 to allow healthshare server 110 to electronically deliver the selected reminders 115 based on the schedule to the patient via patient client 130 (see step 416). In some embodiments, healthshare server 110 forwards the message in HL7 format to electronic health record server 140 for storage in the permanent record of the patient.

FIGS. 6-9 illustrate some of the functionality performed by healthshare server 110. Healthshare server 110 coordinates and monitors the activities of other elements of system 100. FIG. 6 is a flow chart of a method 600 of providing an electronic delivery of education assets 114 to a patient in an exemplary embodiment. Education assets 114 are assigned to a patient, and are electronically delivered to the patient via patient client 130. Control system 111 of healthshare server 110 receives a query from a clinician using clinician client 120 for list of education assets 114 that may be assigned to a patient (see step 602). In response to the query from clinician client 120, control system 111 provides the list of education assets 114 to clinician client 120 (see step 604). For instance, control system 111 may generate a list of education assets 114 stored in memory 113, may generate a plurality of thumbnail images or preview images of education assets 114 stored in memory 113, may generate text descriptions of education assets 114 stored in memory 113, and provide this information to clinician client 120. Control system 111 receives a message from clinician client 120 that indicates which education assets 114 have been selected by the clinician (see step 606). Control system 111 retrieves the education asset(s) 114 identified in the message (see step 608). For instance, control system 11 may locate education assets 114 stored in memory 113, may query an external provider of education assets 114, etc. Control system 111 provides an electronic delivery of one or more education assets 114 to patient client 130 (see step 610). Electronic delivery may entail a digital download of education assets 114 to patient client 130, may entail providing patient client 130 with a resource link (e.g., a Hypertext Transfer Protocol (HTTP) link), which the patient may access via a web browser and web client operating on patient client 130 (e.g., using GUI 132 of patient client 130), etc. The specifics of how a patient interacts with system 100 to retrieve education assets 114 assigned to them will be discussed later.

In some embodiments, control system 111 provides education assets 114 to patient client 130 upon request for immediate viewing by the patient. In some embodiments, patient client 130 may download education assets 114 for viewing at a later time. For example, patient client 130 may download education assets 114 assigned to the patient prior to the patient leaving the hospital. This may be desirable if the patient does not have access to the Internet at home.

In some cases, education assets 114 assigned to a patient may be modified by variable data. When messages from clinician client 120 indicate that variable data is present, then control system 111 modifies education assets 114 to include the variable data prior to electronically delivering education assets 114 to patient client 130. Such a modification may be made upon request or download of education assets 114 by patient client 130 (e.g., modifications are made “on-the-fly”), or the modifications may be made prior to the request, and the modified versions of education assets 114 are stored in memory 113. In some embodiments, control system 111 may provide the variable data and information regarding which education asset 114 to modify to an external service, which provides the asset modification for healthshare server 110.

An aspect of patient engagement is the monitoring of compliance of the patients in viewing the education assets 114 that are assigned to them. Compliance monitoring can identify patients who are non-compliant, therefore at risk for re-admission, allowing the staff to communicate with the patient promptly. Early intervention via a telephone call will reduce the possibility of a re-admittance of the patient to a medical facility after discharge.

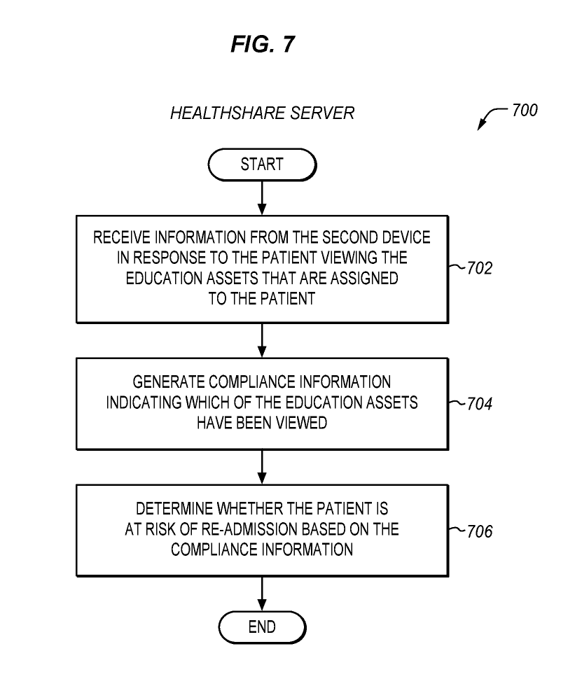

FIG. 7 is a flow chart of a method 700 of analyzing compliance for education assets assigned to a patient in an exemplary embodiment. Control system 111 of healthshare server 110 receives information from patient client 130 indicating that the patient has viewed education assets 114 assigned to them (see step 702). For example, patient client 130 may provide a notification to control system 111 when the patient watches an education video assigned to them, may provide a notification to control system 111 when a patient opens an educational document assigned to them, in response to the patient answering questions presented to the patient during presentation of the education asset, etc. In response to receiving these types of compliance information from patient client 130, control system 111 generates compliance information indicating which of education assets 114 have been viewed by the patient using patient client 130 (see step 704). Control system 111 then determines whether the patient is at risk of re-admittance based on the compliance information (see step 706). For example, patients that have not viewed any of their education assets 114 may be at a high risk of re-admission. This information will be discussed later with respect to the clinical follow-up workflow.

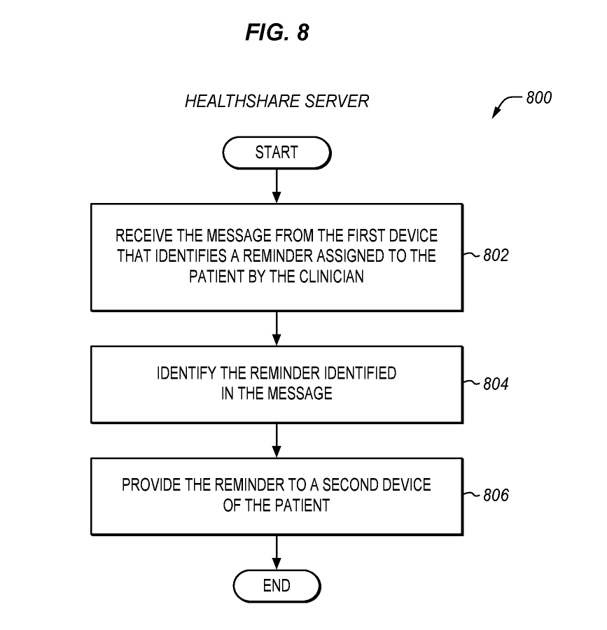

FIG. 8 is a flow chart of a method 800 of providing an electronic delivery of reminders 115 to a patient in an exemplary embodiment. Reminders 115 are assigned to a patient, and are electronically delivered to the patient via patient client 130. This functionality is performed by healthshare server 110. Control system 111 receives a message from clinician client 120 that indicates which reminders 115 have been assigned to the patient (see step 802), and identifies one or more reminders 115 in the message (see step 804). Control system 111 then provides an electronic delivery of the one or more reminders 115 to patient client 130 (see step 806).

In some embodiments, one or more reminders 115 may be automatically generated by healthshare server 110 for a patient. For instance, control system 111 may query electronic health record server 140 for an electronic heath record of the patient, and process the electronic health record to identify one or more medical conditions of the patient. Control system 111 may then automatically generate and assign one or more reminders 115 to the patient based on the medical condition(s), and provide reminder(s) 115 to patient client 130. In a push notification, control system 111 stores the reminder until the appropriate time, and then pushes the reminder to patient client 130. In a forward and store notification, patient client 130 pulls the reminder from control system 111, and provides the reminder to the patient at the appropriate time using patient client 130.

An aspect of patient engagement is the monitoring of compliance of the patients in completing the reminders 115 that are assigned to them. Compliance monitoring can reduce the possibility of a re-admittance of the patient to a medical facility after discharge.

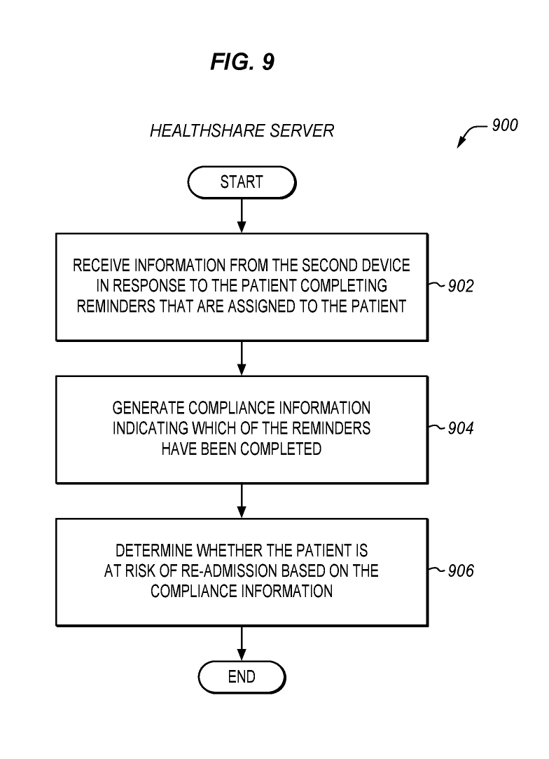

FIG. 9 is a flow chart of a method 900 of analyzing compliance for reminders 115 assigned to a patient in an exemplary embodiment. Control system 111 of healthshare server 110 receives information from patient client 130 indicating that the patient has completed reminders 115 assigned to them (see step 902). For example, patient client 130 may provide a notification to control system 111 when the patient takes a medication, may provide a notification to control system 111 when a patient performs physical therapy exercises assigned to them, etc. In response to receiving these types of compliance information from patient client 130, control system 111 generates compliance information indicating which of reminders 115 have been completed by the patient using patient client 130 (see step 904). Control system 111 then determines whether the patient is at risk of re-admittance based on the compliance information (see step 906). For example, patients that have not completed any of their reminders 115 may be at a high risk of re-admission. This information will be discussed later with respect to the clinical follow-up workflow.

FIGS. 10-12 illustrate some of the functionality performed by patient client 130. Patients interact with system 100 using patient client 130.

FIG. 10 is a flow chart of a method 1000 of providing an electronic receipt of education assets 114 assigned to a patient in an exemplary embodiment. Education assets 114 are assigned to a patient by a clinician, and are electronically delivered to the patient to patient client 130 by healthshare server 110. To do so, control system 131 of patient client 130 queries healthshare server 110 for an education asset 114 assigned to the patient (see step 1002). For instance, control system 131 may periodically poll healthshare server 110 to determine if education assets 114 have been assigned to the patient and/or if the education assets 114 assigned to the patient have been modified, changed, deleted, etc. Patient client 130 may be pre-programmed with an ID of the patient prior to the patient leaving the hospital with patient client 130 after discharge. Or, the patient may be assigned login information that is entered into patient client 130 by the patient, which is passed on to healthshare server 110 and used by healthshare server 110 to correlate the identity of the patient with the education assets 114 and/or reminders 115 assigned to the patient.

Control system 131 receives education assets 114 assigned to the patient from healthshare server 110 (see step 1004). Control system 131 may download education assets 114 for offline viewing by the patient and/or may allow the patient to view education assets 114 assigned to them in real time. Control system 131 displays education assets 114 assigned to them at GUI 132 (see step 1006). For example, GUI 132 may play a video file, a sound file, display an electronic document, etc.

Control system 131 determines that the patient has viewed education assets 114 assigned to them (see step 1008). For instance, control system 131 of patient client 130 may determine that the patient has viewed a video education asset, that the patient has opened an electronic document for the education asset, etc. Control system 131 provides a message to healthshare server 110 indicating that the patient has viewed education assets 114 assigned to them. The message allows healthshare server 110 to compile compliance information regarding if or when the patient has viewed education assets 114 assigned to them. This information can be used later to determine of the patient is at risk of re-admission (see step 1010).

System 100 may determine that the patient has viewed an education asset 114 assigned to them in a number of ways. For instance, if the patient interacts with patient client 130 via an application, the application executing on patient client 130 may recognize when education assets 114 have been opened at patient client 130. Patient client 130 may generate pop-up notifications when a patient opens an education asset 114 assigned to them.

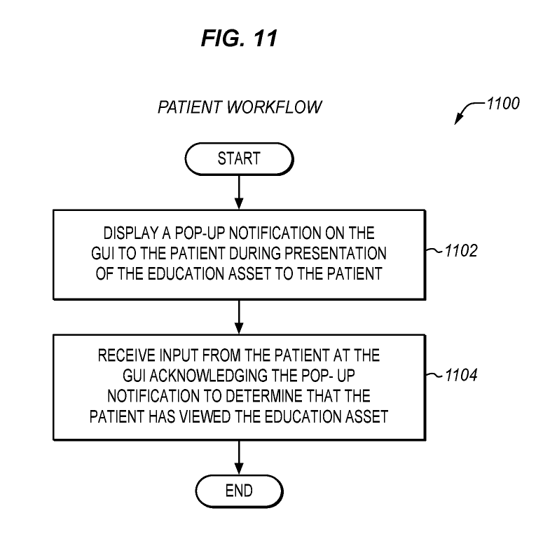

FIG. 11 is a flow chart of a method 1100 of generating compliance information for education assets assigned to a patient in an exemplary embodiment. This embodiment will use a pop-up notification at GUI 132 of patient client 130. In response to presenting an education asset 114 to a patient, control system 131 of patient client 130 displays a pop-up notification on GUI 132 (see step 1102). For example, control system 131 may provide a notification over a video file being played to the patient at patient client 130 requesting input “are you watching? Yes/No/Ignore” to the patient. Or, control system 131 may provide a notification to the patient indicating “do you have any questions regarding this material? Yes/No/Ignore”.

In response to the pop-up notification, the patient uses GUI 132 to provide input acknowledging the pop-up notification. Control system 131 uses this input to determine that the patient has viewed education assets 114 assigned to them (see step 1104).

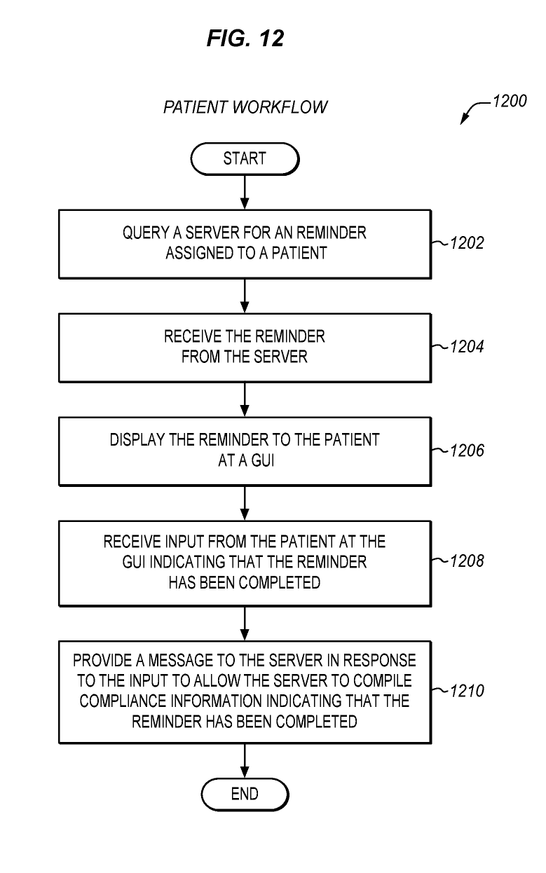

Patient client 130 is also capable of displaying reminders to the patient. FIG. 12 discusses this aspect. FIG. 12 is a flow chart of a method 1200 of providing an electronic receipt of reminders 115 assigned to a patient in an exemplary embodiment. Reminders 115 are assigned to a patient by the clinician, and are electronically delivered to the patient via patient client 130 by healthshare server 110. Control system 131 queries healthshare server 110 for a reminder 115 assigned to the patient (see step 1202). For instance, control system 131 may periodically poll healthshare server 110 to determine if reminders 115 have been assigned to the patient and/or if the reminders 115 assigned to the patient have been modified, changed, deleted, etc.

Control system 131 receives reminders 115 assigned to the patient from healthshare server 110 (see step 1204). Control system 131 displays reminders 115 assigned to them at GUI 132 (see step 1206). For example, GUI 132 may display a reminder for the patient to take a medication, to travel to an appointment, to perform physical therapy exercises, to change a dressing on a wound, etc.

When the patient completes reminders 115 assigned to them, then the patient indicates so on GUI 132 (see step 1208). For instance, control system 131 may generate a notification at GUI for the patient (e.g., “did you take your 5 pm medication? Yes/No/Ignore”).

Control system 131 provides a message to healthshare server 110 indicating that the patient has completed a reminder 115 assigned to them. The message allows healthshare server 110 to compile compliance information regarding if or when the patient has completed their reminders 115. This information can be used later to determine of the patient is at risk of readmission (see step 1210). This will be discussed late with respect to the clinician follow-up workflow.

In some embodiments, the patient is able to send messages to and receive messages from clinical staff using patient client 130. For example, patient client 130 may record a voice message from the patient, and deliver the voice message to the clinical staff via clinician client 120. The clinical staff may use clinician client 120 to listen to the message, and respond in with an audio message for the patient, which is delivered to patient client 130. In addition to audio messages, text messages may be sent to and from the patient to clinical staff using patient client 130. Text messages and/or voice messages may be useful when checking up on the recovery progress of the patient. This type of two-way interaction between the patient and the clinical staff is useful to ensure a positive outcome for the patient after discharge.

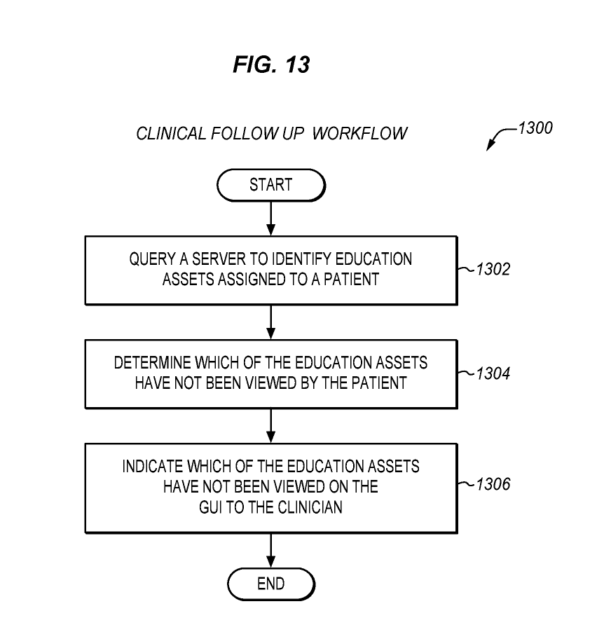

FIGS. 13-16 illustrate some of the functionality performed by clinician client 120 to implement the clinician follow-up workflow. The clinician follow-up workflow relates to compliance monitoring of patients. One aspect of patient engagement and education is compliance monitoring. To reduce the chance that patients will be re-admitted to a medical facility, it is important to identify patients that are at risk of re-admission. System 100 enables this activity by monitoring the compliance of patients in viewing education assets 114 assigned to them. FIG. 13 is a flow chart of a method 1300 of determining compliance for education assets assigned to a patient in an exemplary embodiment.

A clinician is able to utilize system 100 to monitor the compliance of patients in following the education plan assigned to them. To do so, a clinician operates clinician client 120, and logs in to system 100 using GUI 122. For example, clinician client 120 may utilize GUI 122 to display a web browser, which the clinician uses to log into healthshare server 110. The clinician uses clinician client 120 to determine which, if any, of the education assets assigned to a patient have been viewed by the patient. Control system 121 of clinician client 120 queries healthshare server 110 to identify education assets 114 assigned to a patient (see step 1302). Control system 121 determines which of education assets 114 assigned to the patient have not been viewed by the patient (see step 1304). For instance, control system 121 may compare education assets 114 assigned versus education assets 114 that have been viewed. Control system 121 indicates which of the education assets 114 assigned to the patient have not been viewed at GUI 122 (see step 1306). This information may be used by the clinician to evaluate whether or not a particular patient is complying with their education plan.

The clinician can also perform this type of compliance monitoring of education assets 114 on a larger scale, analyzing many patients automatically to determine if some patients are at risk of re-admission.

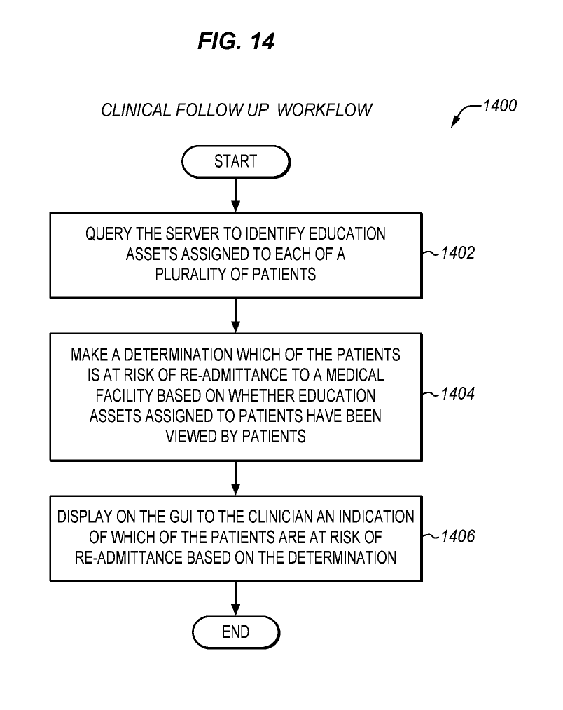

FIG. 14 is a flow chart of a method 1400 of determining a re-admittance risk for patients based on education asset compliance in an exemplary embodiment. Rather than analyzing one patient, control system 121 may analyze a plurality of patients to identify re-admission risk. To do so, control system 121 queries healthshare server 110 to identify education assets 114 assigned to each of a plurality of patients (see step 1402), and then determines which of the patients is at risk of re-admission based on whether education assets 114 assigned to the patients have been viewed by those patients (see step 1404). For instance, analytics may be used to analyze the pattern of how education assets 114 are viewed by patients, and correlated with re-admission risk. Control system 121 displays patients on GUI 122 that may be at risk of re-admittance (see step 1406). This allows the clinician to take some action, such as calling the patients to check up on them. In some embodiments, control system 121 may automatically generate a call list for the clinician of patients that are at risk of re-admittance based on their compliance with education assets 114 assigned to them.

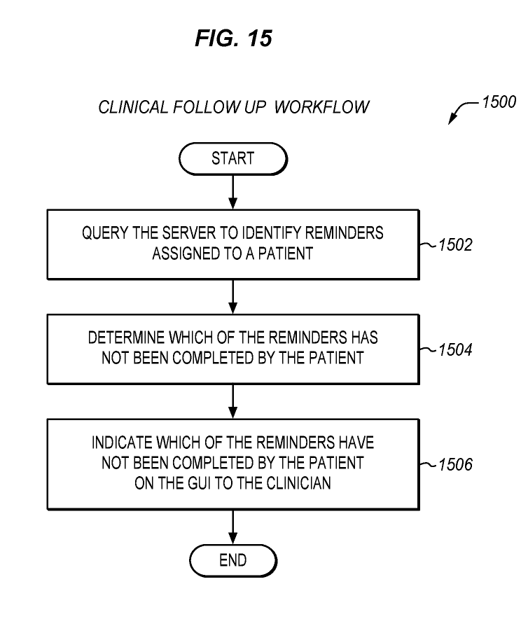

To reduce the chance that patients will be re-admitted to a medical facility, it is important to identify patients that are at risk of re-admission. System 100 enables this activity by monitoring the compliance of patients in completing reminders 115 assigned to them. FIG. 15 is a flow chart of a method 1500 of determining compliance for reminders assigned to a patient in an exemplary embodiment.

A clinician is able to utilize system 100 to monitor the compliance of patients in following the education plan assigned to them. To do so, a clinician operates clinician client 120. The clinician uses clinician client 120 to determine which, if any, of the reminders assigned to a patient have been completed by the patient. Control system 121 of clinician client 120 queries healthshare server 110 to identify reminders 115 assigned to a patient (see step 1502). Control system 121 determines which of reminders 115 assigned to the patient have not been completed by the patient (see step 1504). For instance, control system 121 may compare reminders 115 assigned versus reminders 115 that have been completed. Control system 121 indicates which of the reminders 115 assigned to the patient have not been completed at GUI 122 (see step 1506). This information may be used by the clinician to evaluate whether or not a particular patient is complying with their education plan.

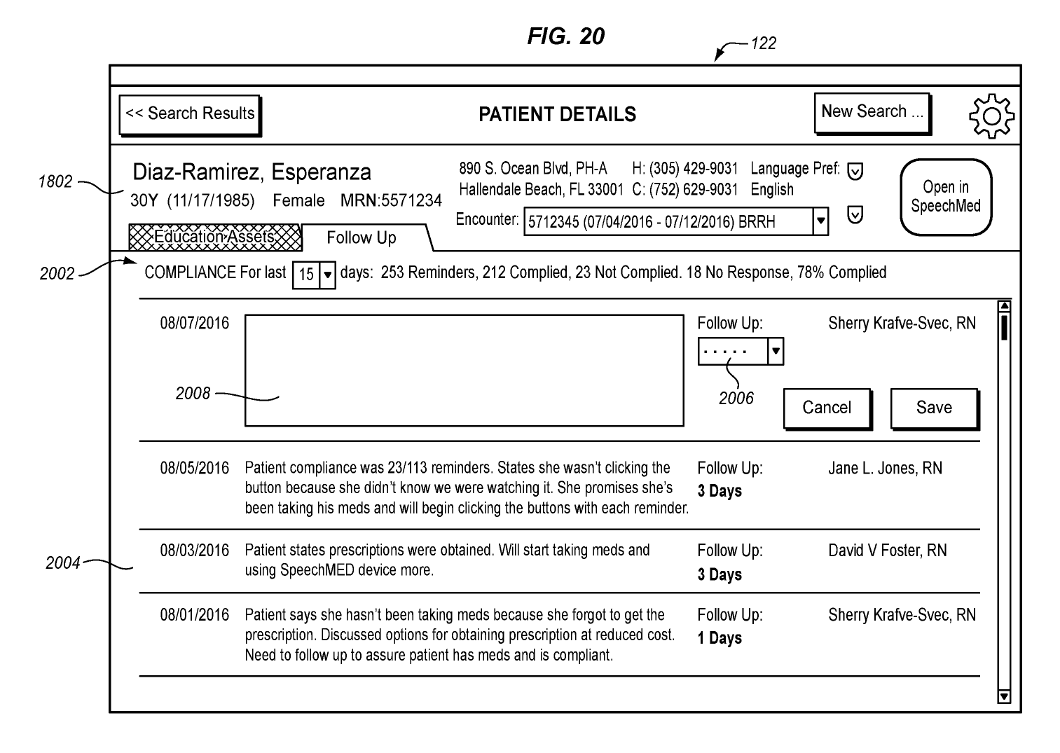

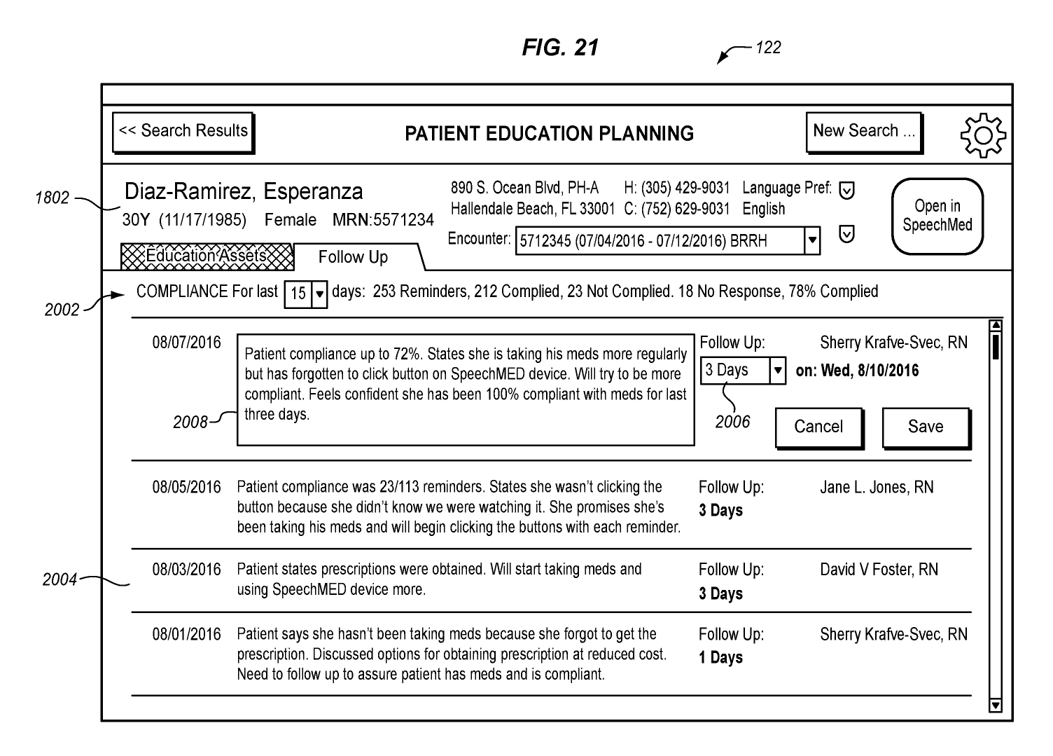

FIG. 20 illustrates a UI screen that may be presented to the clinician at GUI 122 for reviewing compliance information for a patient in an exemplary embodiment. In FIG. 20, compliance information 2002 is illustrated for patient 1802 (Diaz-Ramirez, Esperanza) that indicates 253 total reminders, of which 212 were completed, 23 were not completed, and 18 were marked as “No Response”. The compliance rate is calculated as 78% for patient 1802. FIG. 19 also illustrates a history of entries 2004 by a clinician, documenting the interaction of the clinician with patient 1802 during follow up calls. A subsequent follow up call may be scheduled for patient 1802 using a scheduling button 2006 illustrated in FIG. 20. A text entry field 2008 may be used by the clinician to document the encounter. FIG. 21 illustrates the UI screen of FIG. 20 after the clinician has documented the current encounter with patient 1802 and schedule a follow up call.

The clinician can also perform this type of compliance monitoring of reminders 115 on a larger scale, analyzing many patients automatically to determine if some patients are at risk of re-admission.

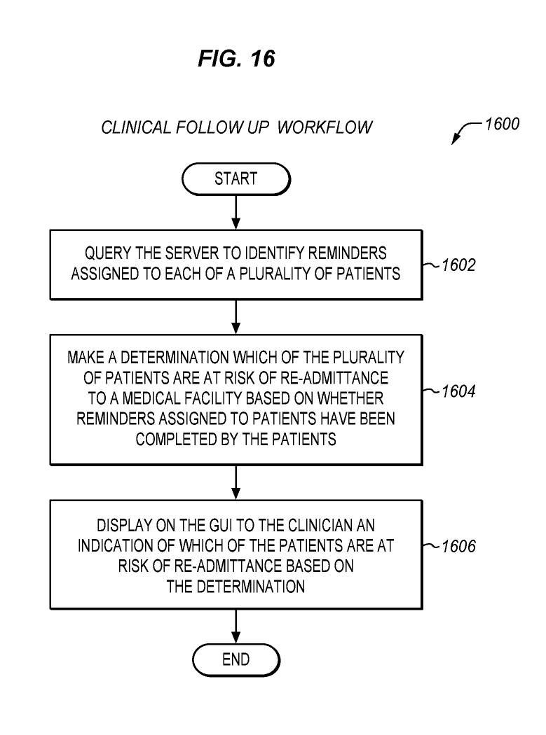

FIG. 16 is a flow chart of a method 1600 of determining a re-admittance risk for patients based on reminder compliance in an exemplary embodiment. Rather than analyzing one patient, control system 121 may analyze a plurality of patients to identify re-admission risk. To do so, control system 121 queries healthshare server 110 to identify reminders 115 assigned to each of a plurality of patients (see step 1602), and then determines which of the patients is at risk of re-admission based on whether reminders 115 assigned to the patients have been completed by those patients (see step 1604). For instance, analytics may be used to analyze the pattern of how reminders are completed by patients, and correlated with re-admission risk. Control system 121 displays patients on GUI 122 that may be at risk of re-admittance. This allows the clinician to take some action, such as calling the patients to check up on them. In some embodiments, control system 121 may automatically generate a call list for the clinician of patients that are at risk of re-admittance based on their compliance with reminders 115 assigned to them.

One aspect that system 100 provides is the ability to modify education assets 114 and reminders 115 that have been assigned to a patient. In some cases, follow up with a patient may change which education assets 114 and/or reminders 115 are assigned to a patient. This may occur if medication dosages and/or the frequency of taking the medications changes over time, which may result in new or modified reminders 115 assigned to a patient. And/or, various follow up appointments may be scheduled after discharge, which would result in different reminders. And/or, a medical condition of the patient may change over time, which results in different education assets 114 being assigned to the patient.

A clinician utilizes clinician client 120 to review education assets 114 assigned to a patient, and to make changes to education assets 114. Control system 121 of clinician client 120 queries healthshare server 110 for an identification of education assets 114 assigned to a patient, and GUI 122 of clinician client 120 displays the information to the clinician. The clinician uses GUI 122 to make changes to education assets 114 assigned to the patient. For example, the clinician may add a new education asset, delete an old education asset, change the variable data for an education asset, etc. Control system 121 generates a message that identifies the changes, and sends the message to healthshare server 110. Healthshare server 110 may then provide the changes for education assets 114 to patient client 130.

Clinicians are required to document their interactions with patients after discharge. Patient interactions normally take place via a telephone call. The clinician can review documentation of previous post-discharge calls and messages, and then document the current interaction and set a call-back date for a patient after a phone call. The call-back date is used to add that patient to the call list for as many days in the future as the call back date is set. System 100 will save the text documentation and can optionally send it back to the electronic heath record server 140 as a HL7 message for the permanent medical record of the patient.

System 100 provides a complete solution regarding managing the post-discharge care of patients, including the assignment of educational assets 114 that provide patient education post-discharge, and the generation and assignment of reminders 115 that help patients remember the tasks that they should perform after discharge. System 100 further provides feedback to a clinician regarding which, if any, education assets 114 and reminders 115 have been viewed or acknowledged by patients. This information can be useful to determine which patients may be at risk of re-admission to a hospital or clinic, which can reduce the readmission rate and therefore, cost, to hospitals or clinics.

Any of the functionality for system 100 described herein may be implemented as hardware, software, firmware, or some combination of these. Some of the elements in the figures may be implemented as dedicated physical hardware. Dedicated physical hardware elements may be referred to as “processors”, “controllers”, “memory”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, physical hardware embodiments comprising digital signal processor (DSP) hardware, a network processor hardware, application specific integrated circuit (ASIC) hardware or other circuitry hardware, field programmable gate array (FPGA) hardware, read only memory (ROM) hardware, random access memory (RAM) hardware, non-volatile storage hardware, logical circuit hardware, or some other physical hardware system, physical component, or physical device.

Also, the functionality described herein for system 100 may be implemented as instructions executable by a processor or a computer to perform the functions of the element. Some examples of instructions are software, program code, and firmware. The instructions are operational when executed by the processor to direct the processor to perform the functions of the element. The instructions may be stored on physical storage devices, also referred to as hardware memory, that are readable by the processor. Some examples of the storage devices are digital or solid-state hardware memories, magnetic storage media such as a magnetic disks and magnetic tapes, hard drives, or optically readable digital data storage media.

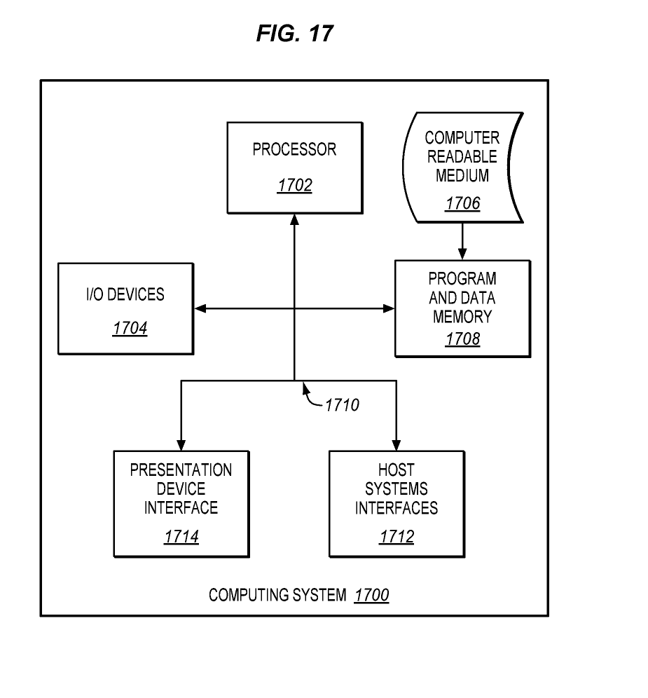

FIG. 17 is a block diagram of a computer system 1700 for implementing the functionality described herein in an exemplary embodiment. Furthermore, embodiments may comprise a computer program product accessible from a computer-usable or computer-readable medium 1706 providing program code for use by or in connection with a computer or any instruction execution system. For the purposes of this description, a computer-usable or computer-readable medium 1706 can be any non-transitory physical apparatus that can contain, store, communicate, or transport the program for use by or in connection with the instruction execution system, apparatus, or device.

Computer-readable medium 1706 can be an electronic, magnetic, optical, electromagnetic, or semiconductor system (or apparatus or device). Examples of a computer-readable medium 1706 include a semiconductor or solid state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include one or more processors 1702 coupled directly or indirectly to memory 1708 through a system bus 1710. The memory 1708 can include local memory employed during actual execution of the program code, bulk storage, and cache memories which provide temporary storage of at least some program code in order to reduce the number of times code is retrieved from bulk storage during execution.

Input/output or I/O devices 1704 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 1712, or remote printers or storage devices through intervening private or public networks. Modems, cable modem and Ethernet cards are just a few of the currently available types of network adapters. A presentation device interface (I/F) 1714 may be used to present information to a user.

Although specific embodiments were described herein, the scope of the invention is not limited to those specific embodiments. The scope of the invention is defined by the following claims and any equivalents thereof.

What is claimed is:

1. A patient engagement and education system, comprising:
a user interface configured to display a Graphical User Interface (GUI) to a patient; and
a control system communicatively coupled to the user interface and a server, the control system configured to query the server for an education asset assigned to the patient, to receive the education asset from the server, to display the education asset to the patient at the GUI, to make a determination that the patient has viewed the education asset, and to provide a message to the server in response to the determination to allow the server to compile compliance information indicating that the education asset has been viewed.

2. The patient engagement and education system of claim 1, wherein:
the control system is further configured to display a pop-up notification on the GUI to the patient during presentation of the education asset to the patient, and to receive input from the patient at the GUI acknowledging the pop-up notification to determine that the patient has viewed the education asset.

3. The patient engagement and education system of claim 1, wherein:
the education asset includes variable data for that patient.

4. The patient engagement and education system of claim 3, wherein the variable data comprises at least one of:
instructions to the patient regarding scheduling of future medical care;
instructions to the patient for at least one of a frequency and type of physical therapy exercise to perform;
instructions to the patient regarding medication schedules and dosages; and
medical test data for the patient.

5. The patient engagement and education system of claim 1, wherein:
the control system is further configured to query the server for a reminder assigned to the patient, to receive the reminder from the server, and to display the reminder to the patient at the GUI,
wherein the control system is further configured to receive input from the patient at the GUI indicating that the reminder has been completed, and to provide a message to the server in response to the input to allow the server to compile compliance information indicating that the reminder has been completed.

6. The patient engagement and education system of claim 1, wherein the education asset comprises at least one of:
the education asset comprises a video related to a medical condition of the patient; and
an electronic document related to a medical condition of the patient.

7. A method, comprising:
querying a server for an education asset assigned to a patient;
receiving the education asset from the server;
displaying the education asset to the patient at a Graphical User Interface (GUI);
making a determination that the patient has viewed the education asset; and
providing a message to the server in response to the determination to allow the server to compile compliance information indicating that the education asset has been viewed.

8. The method of claim 7, further comprising:
displaying a pop-up notification on the GUI to the patient during presentation of the education asset to the patient; and
receiving input from the patient at the GUI acknowledging the pop-up notification to determine that the patient has viewed the education asset.

9. The method of claim 7, wherein:
the education asset includes variable data for that patient.

10. The method of claim 9, wherein the variable data comprises at least one of:
instructions to the patient regarding scheduling of future medical care;
instructions to the patient for at least one of a frequency and type of physical therapy exercise to perform;
instructions to the patient regarding medication schedules and dosages; and
medical test data for the patient.

11. The method of claim 7, further comprising:
querying the server for a reminder assigned to the patient;
receiving the reminder from the server;
displaying the reminder to the patient at the GUI;
receiving input from the patient at the GUI indicating that the reminder has been completed; and
providing a message to the server in response to the input to allow the server to compile compliance information indicating that the reminder has been completed.

12. The method of claim 7, wherein the education asset comprises at least one of:
a video related to a medical condition of the patient; and
an electronic document related to a medical condition of the patient.

13. A non-transitory computer-readable medium having programmed instructions which, when executed by a processor, direct the processor to:
query a server for an education asset assigned to a patient;
receive the education asset from the server;
display the education asset to the patient at a Graphical User Interface (GUI);
make a determination that the patient has viewed the education asset; and
provide a message to the server in response to the determination to allow the server to compile compliance information indicating that the education asset has been viewed.

14. The non-transitory computer-readable medium of claim 13, wherein the programmed instructions further direct the processor to:
display a pop-up notification on the GUI to the patient during presentation of the education asset to the patient; and
receive input from the patient at the GUI acknowledging the pop-up notification to determine that the patient has viewed the education asset.

15. The non-transitory computer-readable medium of claim 13, wherein:
the education asset includes variable data for that patient.

16. The non-transitory computer-readable medium of claim 15, wherein the variable data comprises at least one of:
instructions to the patient regarding scheduling of future medical care;
instructions to the patient for at least one of a frequency and type of physical therapy exercise to perform;
instructions to the patient regarding medication schedules and dosages; and
medical test data for the patient.

17. The non-transitory computer-readable medium of claim 13, wherein the programmed instructions further direct the processor to:
query the server for a reminder assigned to the patient;
receive the reminder from the server;
display the reminder to the patient at the GUI;
receive input from the patient at the GUI indicating that the reminder has been completed; and
provide a message to the server in response to the input to allow the server to compile compliance information indicating that the reminder has been completed.

18. The non-transitory computer-readable medium of claim 13, wherein the education asset comprises at least one of:
a video related to a medical condition of the patient; and
an electronic document related to a medical condition of the patient.
